(19) United States
(12) Patent Application Publication
(10) Pub. No.: US 2009/0165384 A1
(43) Pub. Date: Jul. 2, 2009

(54) Continuous Process for Converting Carbonaceous Feedstock into Gaseous Products

(75) Inventors: Francis S. Lau, Darien, IL (US); Earl T. Robinson, Lakeland, FL (US)

Correspondence Address: MCDONNELL BOEHNEN HULBERT & BERGHOFF LLP, 300 S. WACKER DRIVE, SUITE 3100, CHICAGO, IL, 60606, US

(73) Assignee: GREATPOINT ENERGY, INC., Chicago, IL (US)

(21) Appl. No.: 12/343,159

(22) Filed: Dec. 23, 2008

Related U.S. Application Data
(60) Provisional application No. 61/017,322, filed on Dec. 28, 2007.

(51) Int. Cl. C01B 3/26

(52) U.S. Cl. 48/214 A

(57) ABSTRACT

Continuous processes for converting a carbonaceous feedstock into a plurality of gaseous products are described. The continuous processes include, among other steps, recovering a substantial portion of alkali metal from the solid char that results from the gasification of a carbonaceous feedstock. The alkali metal is recovered as an alkali metal carbonate. A gasification catalyst for a subsequent gasification step may comprise the recovered alkali metal carbonate and a makeup amount of alkali metal hydroxide.

### CROSS-REFERENCE TO RELATED APPLICATIONS

This application claims priority under 35 U.S.C. §119 from U.S. Provisional Application Ser. No. 61/017,322 (filed Dec. 28, 2007), the disclosure of which is incorporated by reference herein for all purposes as if fully set forth.

### FIELD OF THE INVENTION

The present invention relates to continuous processes for converting a carbonaceous feedstock into a plurality of gaseous products. Further, the invention relates to continuous gasification processes that use, as a gasification catalyst, alkali metal compounds recovered from char that forms in the reactor as a by-product of the gasification process.

### BACKGROUND OF THE INVENTION

In view of numerous factors such as higher energy prices and environmental concerns, the production of value-added gaseous products from lower-fuel-value carbonaceous feedstocks, such as petroleum coke and coal, is receiving renewed attention. The catalytic gasification of such materials to produce methane and other value-added gases is disclosed, for example, in U.S. Pat. No. 3,828,474, U.S. Pat. No. 3,998,607, U.S. Pat. No. 4,057,512, U.S. Pat. No. 4,092,125, U.S. Pat. No. 4,094,650, U.S. Pat. No. 4,204,843, U.S. Pat. No. 4,468,231, U.S. Pat. No. 4,500,323, U.S. Pat. No. 4,541,841, U.S. Pat. No. 4,551,155, U.S. Pat. No. 4,558,027, U.S. Pat. No. 4,606,105, U.S. Pat. No. 4,617,027, U.S. Pat. No. 4,609,456, U.S. Pat. No. 5,017,282, U.S. Pat. No. 5,055,181, U.S. Pat. No. 6,187,465, U.S. Pat. No. 6,790,430, U.S. Pat. No. 6,894,183, U.S. Pat. No. 6,955,695, US2003/0167961A1, US2006/0265953A1, US2007/000177A1, US2007/083072A1, US2007/0277437A1 and GB 1599932.

Gasification of a carbonaceous material, such as coal or petroleum coke, can be catalyzed by loading the carbonaceous material with a catalyst comprising an alkali metal source. Previously incorporated US2007/0000177A1 and US2007/0083072A1 disclose the alkali-metal-catalyzed gasification of carbonaceous materials. Lower-fuel-value carbon sources, such as coal, typically contain quantities of inorganic matter, including compounds of silicon, aluminum, calcium, iron, vanadium, sulfur, and the like. This inorganic content is referred to as ash. Silica and alumina are especially common ash components. At temperatures above 500-600° C., alkali metal compounds can react with the alumina and silica to form alkali metal aluminosilicates. As an aluminosilicate, the alkali metal compound is substantially insoluble in water and has little effectiveness as a gasification catalyst.

At typical gasification temperatures, most components of ash are not gasified, and thus build up with other compounds in the gasification reactor as a solid residue referred to as char. For catalytic gasification, char generally includes ash, unconverted carbonaceous material, and alkali metal compounds (from the catalyst). The char must be periodically withdrawn from the reactor through a solid purge. The char may contain substantial quantities of alkali metal compounds. The alkali metal compounds may exist in the char as soluble species, such as potassium carbonate, but may also exist as insoluble species, such as potassium aluminosilicate (e.g., kaliophilite). It is desirable to recover the soluble and the insoluble alkali metal compounds from the solid purge for subsequent reuse as a gasification catalyst. In this manner, the alkali metal compounds recovered from the char may be recycled and reused for a subsequent gasification process. Therefore, a need remains for continuous gasification processes that include the substantial recovery of alkali metal compounds from char, where the recovered alkali metal compounds are reused as a catalyst. In this manner, such processes may reduce the use of consumable raw materials, and generate fewer waste products that require disposal.

### BRIEF DESCRIPTION OF THE DRAWINGS

FIG. 1 depicts a schematic for a continuous process for converting a carbonaceous feedstock into a plurality of gaseous products that includes the recovery of alkali metal compounds from char for reuse as a catalyst.

### SUMMARY OF THE INVENTION

In a first aspect, the present invention provides a continuous process for converting a carbonaceous feedstock into a plurality of gaseous products, the process comprising the steps of: (a) supplying a carbonaceous feedstock and a gasification catalyst to a gasification reactor, the gasification catalyst comprising potassium compounds; (b) reacting the carbonaceous feedstock in the gasification reactor in the presence of steam and the gasification catalyst under suitable temperature and pressure to form: (i) a plurality of gaseous products comprising methane and at least one or more of hydrogen, carbon monoxide, carbon dioxide, hydrogen sulfide, ammonia, and other higher hydrocarbons; and (ii) a solid char comprising potassium as soluble and insoluble compounds; (c) at least partially separating the plurality of gaseous products to produce a gas stream comprising a predominant amount of one of the gaseous products; (d) recovering the gas stream; (e) recovering a substantial portion of the potassium compounds from the solid char as potassium carbonate, wherein (1) at least a portion of the potassium is not recovered from the solid char; (2) the gasification catalyst and carbonaceous feedstock are provided to maintain a steady-state operational molar ratio of potassium atoms in the catalyst to carbon atoms in the carbonaceous feedstock, the steady-state operational molar ratio ranging from about 0.01 to about 0.08; and (3) the gasification catalyst comprises the potassium carbonate recovered from the solid char and a makeup potassium hydroxide, the makeup potassium hydroxide added in an amount to maintain the steady-state operational molar ratio.

### DETAILED DESCRIPTION

The present invention provides processes for the continuous catalytic conversion of a carbonaceous composition into a plurality of gaseous products with recovery and reuse of alkali metal used in the gasification catalyst. The alkali metal is recovered from char that develops as a result of the catalyzed gasification of a carbonaceous material in a gasification reactor. The alkali metal is typically recovered as a carbonate, which may then be used as at least part of the gasification catalyst for a subsequent gasification. Because not all of the alkali metal used as a catalyst can be recovered from the solid char, an amount of alkali metal hydroxide may be added to the recovered alkali metal carbonate to make up for unrecovered alkali metal.

The present invention can be practiced, for example, using any of the developments to catalytic gasification technology disclosed in commonly owned US2007/0000177A1, US2007/0083072A1 and US2007/0277437A1; and U.S. patent application Ser. Nos. 12/178,380 (filed 23 Jul. 2008), Ser. No. 12/234,012 (filed 19 Sep. 2008) and Ser. No. 12/234,018 (filed 19 Sep. 2008). Moreover, the processes of the present invention can be practiced in conjunction with the subject matter of the following U.S. Patent Applications, each of which was filed on even date herewith: Ser. No. ______, entitled “CONTINUOUS PROCESSES FOR CONVERTING CARBONACEOUS FEEDSTOCK INTO GASEOUS PRODUCTS” (attorney docket no. FN-0018 US NP1); Ser. No. ______, entitled “CATALYTIC GASIFICATION PROCESS WITH RECOVERY OF ALKALI METAL FROM CHAR” (attorney docket no. FN-0007 US NP1); Ser. No. ______, entitled “PETROLEUM COKE COMPOSITIONS FOR CATALYTIC GASIFICATION” (attorney docket no. FN-0011 US NP1); Ser. No. ______, entitled “CARBONACEOUS FUELS AND PROCESSES FOR MAKING AND USING THEM” (attorney docket no. FN-0013 US NP1); Ser. No. ______, entitled “CATALYTIC GASIFICATION PROCESS WITH RECOVERY OF ALKALI METAL FROM CHAR” (attorney docket no. FN-0014 US NP1); Ser. No. ______, entitled “COAL COMPOSITIONS FOR CATALYTIC GASIFICATION” (attorney docket no. FN-0009 US NP1); Ser. No. ______, entitled “PROCESSES FOR MAKING SYNTHESIS GAS AND SYNGAS-DERIVED PRODUCTS” (attorney docket no. FN-0010 US NP1); Ser. No. ______, entitled “CATALYTIC GASIFICATION PROCESS WITH RECOVERY OF ALKALI METAL FROM CHAR” (attorney docket no. FN-0015 US NP1); Ser. No. ______, entitled “CATALYTIC GASIFICATION PROCESS WITH RECOVERY OF ALKALI METAL FROM CHAR” (attorney docket no. FN-0016 US NP1); Ser. No. ______, entitled “STEAM GENERATING SLURRY GASIFIER FOR THE CATALYTIC GASIFICATION OF A CARBONACEOUS FEEDSTOCK” (attorney docket no. FN-0017 US NP1); and Ser. No. ______, entitled “PROCESSES FOR MAKING SYNGAS-DERIVED PRODUCTS” (attorney docket no. FN-0012 US NP1). All of the above are incorporated herein by reference for all purposes as if fully set forth.

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present invention be limited to the specific values recited when defining a range.

When the term “about” is used in describing a value or an end-point of a range, the invention should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting.

### Carbonaceous Feedstock

The term “carbonaceous feedstock” as used herein refers to a carbonaceous material that is used as a feedstock in a catalytic gasification reaction. The carbonaceous feedstock can be formed, for example, from coal, petroleum coke, liquid petroleum residues, asphaltenes or mixtures thereof The carbonaceous feedstock can come from a single source, or from two or more sources. For example, the carbonaceous feedstock can be formed from one or more tar sands petcoke materials, one or more coal materials, or a mixture of the two. In one embodiment of the invention, the carbonaceous feedstock is coal, petroleum coke, or a mixture thereof.

The term “petroleum coke” as used herein includes both (i) the solid thermal decomposition product of high-boiling hydrocarbon fractions obtained in petroleum processing (heavy residues—“resid petcoke”) and (ii) the solid thermal decomposition product of processing tar sands (bituminous sands or oil sands—“tar sands petcoke”). Such carbonization products include, for example, green, calcined, needle and fluidized bed petroleum coke.

Resid petcoke can be derived from a crude oil, for example, by coking processes used for upgrading heavy-gravity residual crude oil, which petroleum coke contains ash as a minor component, typically about 1.0 wt % or less, and more typically about 0.5 wt % of less, based on the weight of the coke. Typically, the ash in such lower-ash cokes predominantly comprises metals such as nickel and vanadium.

Tar sands petcoke can be derived from an oil sand, for example, by coking processes used for upgrading oil sand. Tar sands petcoke contains ash as a minor component, typically in the range of about 2 wt % to about 12 wt %, and more typically in the range of about 4 wt % to about 12 wt %, based on the overall weight of the tar sands petcoke. Typically, the ash in such higher-ash cokes predominantly comprises materials such as compounds of silicon and/or aluminum.

The petroleum coke (either resid petcoke or tar sands petcoke) can comprise at least about 70 wt % carbon, at least about 80 wt % carbon, or at least about 90 wt % carbon, based on the total weight of the petroleum coke. Typically, the petroleum coke comprises less than about 20 wt % percent inorganic compounds, based on the weight of the petroleum coke.

Petroleum coke in general has an inherently low moisture content typically in the range of from about 0.2 to about 2 wt %. (based on total petroleum coke weight); it also typically has a very low water soaking capacity to allow for conventional catalyst impregnation methods.

The term “liquid petroleum residue” as used herein includes both (i) the liquid thermal decomposition product of high-boiling hydrocarbon fractions obtained in petroleum processing (heavy residues—“resid liquid petroleum residue”) and (ii) the liquid thermal decomposition product of processing tar sands (bituminous sands or oil sands—“tar sands liquid petroleum residue”). The liquid petroleum residue is substantially non-solid; for example, it can take the form of a thick fluid or a sludge.

Resid liquid petroleum residue can be derived from a crude oil, for example, by processes used for upgrading heavy-gravity crude oil distillation residue. Such liquid petroleum residue contains ash as a minor component, typically about 1.0 wt % or less, and more typically about 0.5 wt % of less, based on the weight of the residue. Typically, the ash in such lower-ash residues predominantly comprises metals such as nickel and vanadium.

Tar sands liquid petroleum residue can be derived from an oil sand, for example, by processes used for upgrading oil sand. Tar sands liquid petroleum residue contains ash as a minor component, typically in the range of about 2 wt % to about 12 wt %, and more typically in the range of about 4 wt % to about 12 wt %, based on the overall weight of the residue. Typically, the ash in such higher-ash residues predominantly comprises materials such as compounds of silicon and/or aluminum.

Asphaltenes typically comprise aromatic carbonaceous solids at room temperature, and can be derived, from example, from the processing of crude oil and crude oil tar sands.

The term “coal” as used herein means peat, lignite, sub-bituminous coal, bituminous coal, anthracite, or mixtures thereof. In certain embodiments, the coal has a carbon content of less than about 85%, or less than about 80%, or less than about 75%, or less than about 70%, or less than about 65%, or less than about 60%, or less than about 55%, or less than about 50% by weight, based on the total coal weight. In other embodiments, the coal has a carbon content ranging up to about 85%, or up to about 80%, or up to about 75% by weight, based on total coal weight. Examples of useful coals include, but are not limited to, Illinois #6, Pittsburgh #8, Beulah (N.D.), Utah Blind Canyon, and Powder River Basin (PRB) coals. Anthracite, bituminous coal, sub-bituminous coal, and lignite coal may contain about 10 wt %, about 5 to about 7 wt %, about 4 to about 8 wt %, and about 9 to about 11 wt %, ash by total weight of the coal on a dry basis, respectively. However, the ash content of any particular coal source will depend on the rank and source of the coal, as is familiar to those skilled in the art. See, for example, “Coal Data: A Reference”, Energy Information Administration, Office of Coal, Nuclear, Electric and Alternate Fuels, U.S. Department of Energy, DOE/EIA-0064(93), February 1995.

The term “ash” as used herein includes inorganic compounds that occur within the carbon source. The ash typically includes compounds of silicon, aluminum, calcium, iron, vanadium, sulfur, and the like. Such compounds include inorganic oxides, such as silica, alumina, ferric oxide, etc., but may also include a variety of minerals containing one or more of silicon, aluminum, calcium, iron, and vanadium. The term “ash” may be used to refer to such compounds present in the carbon source prior to gasification, and may also be used to refer to such compounds present in the char after gasification.

In some embodiments of the invention, the carbonaceous feedstock comprises petroleum coke, for example, as tar sands petcoke, resid petcoke, or combinations thereof. In some embodiments, the carbonaceous feedstock comprises a coal or a mixture of different coals. The carbonaceous feedstock can also comprise various mixtures of one or more petcokes and one or more coals.

Typically, the carbonaceous feedstock sources can be supplied as a fine particulate having an average particle size of from about 25 microns, or from about 250 microns, up to about 500 microns, or up to about 2500 microns. One skilled in the art can readily determine the appropriate particle size for the individual particulates and the particulate composition. For example, when a fluid bed gasification reactor is used, the particulate composition can have an average particle size which enables incipient fluidization of the particulate composition at the gas velocity used in the fluid bed gasification reactor.

The ash content of the carbonaceous feedstock can be, for example, about 20 wt % or less, about 15 wt % or less, about 10 wt % or less, or about 5 wt % or less, depending on the starting ash in the coke source. In certain embodiments, the carbonaceous feedstock has a carbon content ranging from about 75 wt %, or from about 80 wt %, or from about 85 wt %, or from about 90 wt %, up to about 95 wt %, based on the weight of the feedstock.

### Alkali Metal Compounds

As used herein, the term “alkali metal compound” refers to a free alkali metal, as a neutral atom or ion, or to a molecular entity, such as a salt, that contains an alkali metal. Additionally, the term “alkali metal” may refer either to an individual alkali metal compound, as heretofore defined, or may also refer to a plurality of such alkali metal compounds. An alkali metal compound capable of being substantially solubilized by water is referred to as a “soluble alkali metal compound.” Examples of a soluble alkali metal compound include free alkali metal cations and water-soluble alkali metal salts, such as potassium carbonate, potassium hydroxide, and the like. An alkali metal compound incapable of being substantially solubilized by water is referred to as an “insoluble alkali metal compound.” Examples of an insoluble alkali metal compound include water-insoluble alkali metal salts and/or molecular entities, such as potassium aluminosilicate.

### Gasification Catalyst

The term “gasification catalyst” as used herein is a composition that catalyzes the gasification of the carbonaceous feedstock. The catalyst typically comprises an alkali metal component, as alkali metal and/or a compound containing alkali metal.

Suitable alkali metals are selected from the group consisting of lithium, sodium, potassium, rubidium, cesium, and mixtures thereof. Particularly useful are potassium sources. Suitable alkali metal compounds are selected from the group consisting of alkali metal carbonates, hydroxides, bicarbonates, formates, oxalates, amides, acetates, sulfides, halides, and nitrates. For example, the catalyst can comprise one or more of Na₂CO₃, K₂CO₃, Rb₂CO₃, Li₂CO₃, Cs₂CO₃, NaOH, KOH, RbOH, LiOH, CsOH, and particularly, potassium carbonate and/or potassium hydroxide. In some embodiments, the gasification catalyst comprises potassium carbonate and potassium hydroxide. In a some further embodiments, the ratio of potassium carbonate to potassium hydroxide ranges from about 1:1, or from about 3:1, or from about 5:1, or from about 7:1, to about 12:1, or to about 15:1, or to about 25:1, or to about 50:1, based on the relative number of moles of potassium. In some embodiments, the ratio of potassium carbonate to potassium hydroxide is about 9:1, based on the relative number of moles of potassium.

In continuous processes of the invention, an alkali metal carbonate used as a gasification catalyst comprises alkali metal carbonate that has been recovered from the solid char. Because at least a portion of the alkali metal is not recovered from the solid char, discussed infra, and in view of other process losses that inevitably occur in most industrial processes, the gasification catalyst will also comprise a makeup catalyst added in an amount to maintain the steady-state operational molar ratio. In accordance with the present invention, the makeup catalyst comprises a makeup potassium hydroxide, or predominantly a makeup potassium hydroxide, or substantially a makeup potassium hydroxide.

Co-catalysts or other catalyst additives may be utilized, as disclosed in various of the previously incorporated references.

### Catalyst-Loaded Carbonaceous Feedstock

The carbonaceous feedstock is generally loaded with an amount of an alkali metal. Typically, the quantity of the alkali metal in the composition is sufficient to provide a ratio of alkali metal atoms to carbon atoms in a steady-state molar ratio ranging from about 0.01, or from about 0.02, or from about 0.03, or from about 0.04, to about 0.06, or to about 0.07, or to about 0.08. Further, the alkali metal is typically loaded onto a carbon source to achieve an alkali metal content of from about 3 to about 10 times more than the combined ash content of the carbonaceous material (e.g., coal and/or petroleum coke), on a mass basis.

Any methods known to those skilled in the art can be used to associate one or more gasification catalysts with the carbonaceous feedstock. Such methods include, but are not limited to, admixing with a solid catalyst source and impregnating the catalyst onto the carbonaceous solid. Several impregnation methods known to those skilled in the art can be employed to incorporate the gasification catalysts. These methods include, but are not limited to, incipient wetness impregnation, evaporative impregnation, vacuum impregnation, dip impregnation, and combinations of these methods. Gasification catalysts can be impregnated into the carbonaceous solids by slurrying with a solution (e.g., aqueous) of the catalyst.

When the carbonaceous feedstock is slurried with a solution of the catalyst, the resulting slurry can be dewatered to provide a catalyzed feedstock, typically, as a wet cake. The catalyst solution for slurrying the carbonaceous particulate can be prepared from any catalyst source in the present methods, including fresh or make-up catalyst and recycled catalyst or catalyst solution (infra). Methods for dewatering the slurry to provide a wet cake of the catalyzed feedstock include filtration (gravity or vacuum), centrifugation, and a fluid press.

Alternatively, slurried carbonaceous feedstock can be dried with a fluid bed slurry drier (e.g., treatment with superheated steam to vaporize the liquid), or the solution evaporated, to provide a dry catalyzed feedstock.

That portion of the carbonaceous feedstock of a particle size suitable for use in the gasifying reactor can then be further processed, for example, to impregnate one or more catalysts and/or cocatalysts by methods known in the art, for example, as disclosed in U.S. Pat. No. 4,069,304 and U.S. Pat. No. 5,435,940; previously incorporated U.S. Pat. No. 4,092,125, U.S. Pat. No. 4,468,231 and U.S. Pat. No. 4,551,155; previously incorporated U.S. patent application Ser. Nos. 12/234,012 and 12/234,018; and previously incorporated U.S. patent applications Ser. No. ______, entitled “PETROLEUM COKE COMPOSITIONS FOR CATALYTIC GASIFICATION” (attorney docket no. FN-0008 US NP1), Ser. No. ______, entitled “PETROLEUM COKE COMPOSITIONS FOR CATALYTIC GASIFICATION” (attorney docket no. FN-0011 US NP1), and Ser. No. ______, entitled “COAL COMPOSITIONS FOR CATALYTIC GASIFICATION” (attorney docket no. FN-0009 US NP1).

One particular method suitable for combining the coal particulate with a gasification catalyst to provide a catalyzed carbonaceous feedstock where the catalyst has been associated with the coal particulate via ion exchange is described in previously incorporated U.S. patent application Ser. No. 12/178,380 (filed 23 Jul. 2008). The catalyst loading by ion exchange mechanism is maximized (based on adsorption isotherms specifically developed for the coal), and the additional catalyst retained on wet including those inside the pores is controlled so that the total catalyst target value is obtained in a controlled manner. Such loading provides a catalyzed coal particulate as a wet cake. The catalyst loaded and dewatered wet coal cake typically contains, for example, about 50% moisture. The total amount of catalyst loaded is controlled by controlling the concentration of catalyst components in the solution, as well as the contact time, temperature and method, as can be readily determined by those of ordinary skill in the relevant art based on the characteristics of the starting coal.

The catalyzed feedstock can be stored for future use or transferred to a feed operation for introduction into the gasification reactor. The catalyzed feedstock can be conveyed to storage or feed operations according to any methods known to those skilled in the art, for example, a screw conveyer or pneumatic transport.

In some embodiments, the resulting catalyst-loaded carbonaceous particulate composition has a moisture content of less than about 6 wt %, or less than about 4 wt %, based on the total weight of the particulate composition. In some embodiments, the particulate composition comprises from about 5 wt %, or from about 7.5 wt %, or from about 10 wt %, to about 20 wt %, or to about 25 wt % gasification catalyst. In some embodiments, the particulate composition comprises about 15 wt % gasification catalyst.

### Catalytic Gasification Methods

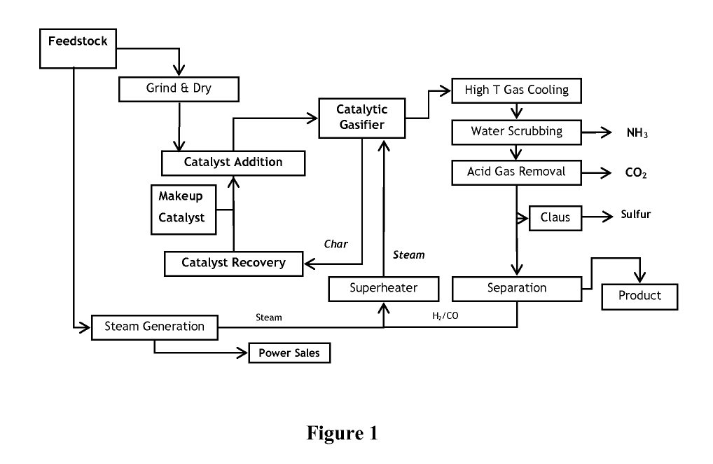

The process of the present invention is an integrated gasification processes for converting carbonaceous feedstocks to combustible gases, such as methane. A typical flow chart for integration into a process for generating a combustible gas from a carbonaceous feedstock is illustrated in FIG. 1, and referenced herein.

The gasification reactors for such processes are typically operated at moderately high pressure and temperature, requiring introduction of the particulate composition to the reaction zone of the gasification reactor while maintaining the required temperature, pressure, and flow rate of the feedstock. Those skilled in the art are familiar with feed systems for providing feedstocks to high pressure and/or temperature environments, including, star feeders, screw feeders, rotary pistons, and lock-hoppers. It should be understood that the feed system can include two or more pressure-balanced elements, such as lock hoppers, which would be used alternately.

Suitable gasification reactors include counter-current fixed bed, co-current fixed bed, fluidized bed, entrained flow, and moving bed reactors. The gasification reactor typically will be operated at moderate temperatures of at least about 450° C., or of at least about 600° C. or above, to about 900° C., or to about 750° C., or to about 700° C.; and at pressures of at least about 50 psig, or at least about 200 psig, or at least about 400 psig, to about 1000 psig, or to about 700 psig, or to about 600 psig.

The gas utilized in the gasification reactor for pressurization and reactions of the particulate composition typically comprises steam, and optionally, oxygen, air, CO, and/or H₂, and is supplied to the reactor according to methods known to those skilled in the art. Typically, the carbon monoxide and hydrogen produced in the gasification is recovered and recycled. In some embodiments, however, the gasification environment remains substantially free of air, particularly oxygen. In one embodiment of the invention, the reaction of the carbonaceous feedstock is carried out in an atmosphere having less than about 1% oxygen by volume.

Any of the steam boilers known to those skilled in the art can supply steam to the reactor. Such boilers can be powered, for example, through the use of any carbonaceous material such as powdered coal, biomass etc., and including but not limited to rejected carbonaceous materials from the particulate composition preparation operation (e.g., fines, supra). Steam can also be supplied from a second gasification reactor coupled to a combustion turbine where the exhaust from the reactor is thermally exchanged to a water source and produce steam.

Recycled steam from other process operations can also be used for supplying steam to the reactor. For example, when the slurried particulate composition is dried with a fluid bed slurry drier, as discussed previously, the steam generated through vaporization can be fed to the gasification reactor.

The small amount of required heat input for the catalytic coke gasification reaction can be provided by superheating a gas mixture of steam and recycle gas feeding the gasification reactor by any method known to one skilled in the art. In one method, compressed recycle gas of CO and H₂ can be mixed with steam and the resulting steam/recycle gas mixture can be further superheated by heat exchange with the gasification reactor effluent followed by superheating in a recycle gas furnace.

A methane reformer can be included in the process to supplement the recycle CO and H₂ fed to the reactor to ensure that the reaction is run under thermally neutral (adiabatic) conditions. In such instances, methane can be supplied for the reformer from the methane product, as described below.

Reaction of the particulate composition under the described conditions typically provides a crude product gas and a char. The char produced in the gasification reactor during the present processes typically is removed from the gasification reactor for sampling, purging, and/or catalyst recovery. Methods for removing char are well known to those skilled in the art. One such method taught by EP-A-0102828, for example, can be employed. The char can be periodically withdrawn from the gasification reactor through a lock hopper system, although other methods are known to those skilled in the art.

Crude product gas effluent leaving the gasification reactor can pass through a portion of the gasification reactor which serves as a disengagement zone where particles too heavy to be entrained by the gas leaving the gasification reactor are returned to the fluidized bed. The disengagement zone can include one or more internal cyclone separators or similar devices for removing particulates from the gas. The gas effluent passing through the disengagement zone and leaving the gasification reactor generally contains CH₄, CO₂, H₂, CO, H₂S, NH₃, unreacted steam, entrained fines, and other contaminants such as COS.

Residual entrained fines can also be removed by any suitable means such as external cyclone separators followed by Venturi scrubbers. The recovered fines can be processed to recover alkali metal catalyst.

Processes have been developed to recover alkali metal from the solid purge in order to reduce raw material costs and to minimize environmental impact of a catalytic gasification process. The char can be quenched with recycle gas and water and directed to a catalyst recycling operation for extraction and reuse of the alkali metal catalyst. Particularly useful recovery and recycling processes are described in U.S. Pat. No. 4,459,138, as well as previously incorporated U.S. Pat. No. 4,057,512, US2007/0277437A1, U.S. patent application Ser. No. ______, entitled “CATALYTIC GASIFICATION PROCESS WITH RECOVERY OF ALKALI METAL FROM CHAR” (attorney docket no. FN-0007 US NP1), U.S. patent application Ser. No. ______, entitled “CATALYTIC GASIFICATION PROCESS WITH RECOVERY OF ALKALI METAL FROM CHAR” (attorney docket no. FN-0014 US NP1), U.S. patent application Ser. No. ______, entitled “CATALYTIC GASIFICATION PROCESS WITH RECOVERY OF ALKALI METAL FROM CHAR” (attorney docket no. FN-0015 US NP1), and U.S. patent application Ser. No. ______, entitled “CATALYTIC GASIFICATION PROCESS WITH RECOVERY OF ALKALI METAL FROM CHAR” (attorney docket no. FN-0016 US NP1). Reference can be had to those documents for further process details.

The gas stream from which the fines have been removed can then be passed through a heat exchanger to cool the gas and the recovered heat can be used to preheat recycle gas and generate high pressure steam. The gas stream exiting the Venturi scrubbers can be fed to COS hydrolysis reactors for COS removal (sour process) and further cooled in a heat exchanger to recover residual heat prior to entering water scrubbers for ammonia recovery, yielding a scrubbed gas comprising at least H₂S, CO₂, CO, H₂, and CH₄. Methods for COS hydrolysis are known to those skilled in the art, for example, see U.S. Pat No. 4,100,256.

The residual heat from the scrubbed gas can be used to generate low pressure steam. Scrubber water and sour process condensate can be processed to strip and recover H₂S, CO₂ and NH₃; such processes are well known to those skilled in the art. NH₃ can typically be recovered as an aqueous solution (e.g., 20 wt %).

A subsequent acid gas removal process can be used to remove H₂S and CO₂ from the scrubbed gas stream by a physical absorption method involving solvent treatment of the gas to give a cleaned gas stream. Such processes involve contacting the scrubbed gas with a solvent such as monoethanolamine, diethanolamine, methyldiethanolamine, diisopropylamine, diglycolamine, a solution of sodium salts of amino acids, methanol, hot potassium carbonate or the like. One method can involve the use of Selexol® (UOP LLC, Des Plaines, Ill. USA) or Rectisol® (Lurgi AG, Frankfurt am Main, Germany) solvent having two trains; each train consisting of an H₂S absorber and a CO₂ absorber. The spent solvent containing H₂S, CO₂ and other contaminants can be regenerated by any method known to those skilled in the art, including contacting the spent solvent with steam or other stripping gas to remove the contaminants or by passing the spent solvent through stripper columns. Recovered acid gases can be sent for sulfur recovery processing. The resulting cleaned gas stream contains mostly CH₄, H₂, and CO and, typically, small amounts of CO₂ and H₂O. Any recovered H₂S from the acid gas removal and sour water stripping can be converted to elemental sulfur by any method known to those skilled in the art, including the Claus process. Sulfur can be recovered as a molten liquid.

In certain embodiments of the invention, the plurality of gaseous products are at least partially separated to form a gas stream comprising a predominant amount of one of the gaseous products. For example, the cleaned gas stream can be further processed to separate and recover CH₄ by any suitable gas separation method known to those skilled in the art including, but not limited to, cryogenic distillation and the use of molecular sieves or ceramic membranes. One method for recovering CH₄ from the cleaned gas stream involves the combined use of molecular sieve absorbers to remove residual H₂O and CO₂ and cryogenic distillation to fractionate and recover CH₄. Typically, two gas streams can be produced by the gas separation process, a methane product stream and a syngas stream (H₂ and CO). The syngas stream can be compressed and recycled to the gasification reactor. If necessary, a portion of the methane product can be directed to a reformer, as discussed previously and/or a portion of the methane product can be used as plant fuel.

Further process details can be had by reference to the previously incorporated patents and publications.

### Char

The term “char” as used herein includes mineral ash, unconverted carbonaceous material, and water-soluble alkali metal compounds and water-insoluble alkali metal compounds bound within the other solids. The char produced in the gasification reactor typically is removed from the gasification reactor for sampling, purging, and/or catalyst recovery. Methods for removing char are well known to those skilled in the art. One such method, taught by previously incorporated EP-A-0102828, for example, can be employed. The char can be periodically withdrawn from the gasification reactor through a lock hopper system, although other methods are known to those skilled in the art.

Continuous Process for Converting Carbonaceous Feedstock into Gaseous Products

FIG. 1 provides a flow chart depicting an embodiment of a continuous process for converting carbonaceous feedstock into a plurality of gaseous products, where the gasification catalyst comprises alkali metal compounds recovered from the char.

Alkali metal salts, particularly potassium salts, are useful as catalysts in catalytic gasification reactions. Alkali metal catalyst-loaded carbonaceous mixtures are generally prepared and then introduced into a gasification reactor, or can be formed in situ by introducing alkali metal catalyst and carbonaceous particles separately into the reactor.

After gasification, the alkali metal may exist in the char as species that are either soluble or insoluble. In particular, alkali metal can react with ash at temperatures above about 500-600° C. to form insoluble alkali metal aluminosilicates, such as kaliophilite. As an aluminosilicate, or other insoluble compounds, the alkali metal is ineffective as a catalyst.

As discussed above, char is periodically removed from the gasification reactor through a solid purge. Because the char has a substantial quantity of soluble and insoluble alkali metal, it is desirable to recover the alkali metal from the char for reuse as a gasification catalyst. Catalyst loss in the solid purge must generally be compensated for by a reintroduction of additional catalyst, i.e., a catalyst make-up stream. As discussed above, processes have been developed to recover alkali metal from the solid purge in order to reduce raw material costs and to minimize environmental impact of a catalytic gasification process.

The present invention provides a novel process for the continuous conversion of a carbonaceous feedstock into gaseous products, where the process includes recovering a substantial portion of the alkali metal from the solid char and using the recovered alkali metal compounds as a gasification catalyst in a subsequent gasification of a carbonaceous material.

The following process steps are described in terms of an alkali metal. In some embodiments, the alkali metal is potassium, which exists in the char as soluble and insoluble potassium compounds, and is ultimately recovered as potassium carbonate. The recovered potassium carbonate may then be reused as a gasification catalyst.

1. Supplying Feedstock and Catalyst to the Reactor

Methods for preparing a catalyst-loaded carbonaceous feedstock are provided, supra. This includes preparing the carbonaceous feedstock and associating the feedstock with gasification catalyst.

The catalyst-loaded carbonaceous feedstock is fed into a gasification reactor. As discussed, supra, feed systems for providing feedstocks to high pressure and/or temperature environments, include, but are not limited to star feeders, screw feeders, rotary pistons, and lock-hoppers. The feed system can include two or more pressure-balanced elements, such as lock hoppers, which would be used alternately.

2. Reacting the Catalyst-Loaded Feedstock in the Reactor

Catalytic gasification methods are described above. The reaction may be carried out at pressures and temperatures suitable for forming a solid char and a plurality of gaseous products including methane and at least one of hydrogen, carbon monoxide, carbon dioxide, hydrogen sulfide, ammonia, and other higher hydrocarbons.

As discussed above, the resulting solid char comprises alkali metal. The alkali metal typically results from the use of alkali metal compounds as gasification catalysts. The alkali metal may exist in the solid char as soluble or insoluble alkali metal compounds, as discussed, supra. In some embodiments, the alkali metal is potassium, and the solid char comprises soluble and insoluble potassium compounds.

3. Partial Separation into and Recovery of a Gas Stream

As discussed above, a cleaned gas stream can be processed to separate and recover CH₄ by any suitable gas separation method known to those skilled in the art including, but not limited to, cryogenic distillation and the use of molecular sieves or ceramic membranes.

The partial separation need not result in a gas stream that is substantially pure. The stream only needs to comprise a predominant amount of one gas in comparison to the other gases present in the stream. In some embodiments, the gas stream comprises more than about 40%, or more than about 50%, or more than about 60%, or more than about 70%, or more than about 80%, of a single gas, based on the total moles of gas present in the stream. In some embodiments, the gas stream comprises a predominant amount of methane. In other embodiments, the gas stream comprises a predominant amount of either hydrogen or carbon monoxide.

4. Recovery of Alkali Metalfrom Solid Char

Recovery of the alkali metal from the solid char as an alkali metal carbonate includes, but is not limited to: recovery of soluble and insoluble alkali metal from the insoluble char particulate; separating the liquid portion comprising a substantial portion of the alkali metal from the insoluble matter that has been substantially depleted of alkali metal; and concentrating the alkali metal solution as an alkali metal carbonate solution.

The solid char comprises alkali metal as soluble compounds and insoluble compounds. The relative proportion of soluble to insoluble alkali metal in the char will depend, at least in part, on the composition of the carbonaceous feedstock. For example, the gasification of carbonaceous materials high in alumina content, such as coal and tar sands petcoke, can result in the formation of significant amounts of insoluble alkali metal aluminosilicates in the char. In another example, gasification of carbonaceous materials low in alumina, such as resid petcoke, may form few insoluble alkali metal compounds in the char. Selecting an appropriate method for recovering the alkali metal from the char depends, to an extent, on the quantity of insoluble alkali metal compounds in the solid char.

Methods of recovering alkali metal from insoluble matter, such as char, are discussed above. Suitable methods include, but are not limited to, washing the char particulate with hot water, subjecting the char particulate to an alkaline digestion process, or combinations thereof. When the char comprises few insoluble alkali metal compounds, methods involving hot water may, in many instances, be sufficient to recover a substantial portion of the alkali metal from the char. But when the char has a significant amount of insoluble alkali metal, alkaline digestion methods, for example, may be more appropriate.

After the alkali metal has been recovered from the solid char, the liquid portion of the char slurry is typically separated from the insoluble matter. The separation and recovery of the liquid portion from the insoluble matter may be carried out by typical methods of separating a liquid from a solid particulate. Such methods include, but are not limited to, filtration (gravity or vacuum), centrifugation, decantation, and use of a fluid press. In some embodiments, the solid particulate is washed with water to ensure maximal transfer of the alkali metal into the separated liquid.

In some embodiments, the recovered liquid comprising the recovered alkali metal is concentrated by removal of water. Suitable methods of removing water include, but are not limited to, various evaporation techniques. In some embodiments, evaporation will reduce the amount of water in the recovered solution by an amount in the range of about 40% to about 60%, based on the total moles of water present in the solution prior to evaporation.

Carbonation of the recovered liquid solution results in the recovery of the alkali metal as an alkali metal carbonate. Previously incorporated US2007/0277437A1 provides a description of a suitable means of carbonating the recovered solution and precipitating out the alkali metal carbonate. In some embodiments, carbonation occurs by passing the recovered solution through a carbonator equipped with multiple trays, baffles, or packing material to ensure good contact between the liquid and the carbon dioxide gas. In the presence of carbon dioxide gas, the alkali metal precipitates out of the solution as an alkali metal carbonate. This alkali metal carbonate is collected for reuse as a gasification catalyst.

The recovery step results in the recovery of a substantial portion of the alkali metal from the solid char as an alkali metal carbonate. In some embodiments, about 60% or more, or about 70% or more, or about 80% or more, or about 85% or more, or about 90% or more of the alkali metal from the solid char is recovered as alkali metal carbonate, based on the total moles of alkali metal atoms originally present in the solid char.

The recovery step will typically not recover all alkali metal from the solid char, leaving an insubstantial portion of alkali metal that is not recovered from the char. In some embodiments, about 40% or less, or about 30% or less, or about 20% or less, or about 15% or less, or about 10% or less, of alkali metal is not recovered from the char, based on the total number of moles of alkali metal atoms originally present in the solid char.

### Catalyst Make-Up

In a continuous process, an alkali metal carbonate used as a gasification catalyst comprises alkali metal carbonate that has been recovered from the solid char. In some embodiments, the alkali metal carbonate is potassium carbonate and the makeup catalyst comprises a makeup potassium hydroxide.

Because an insubstantial portion of the alkali metal is not recovered from the solid char, discussed above, the gasification catalyst may also comprise a makeup catalyst added in an amount to maintain the steady-state operational molar ratio. Typically, the quantity of the alkali metal component in the composition is sufficient to provide a ratio of alkali metal atoms to carbon atoms in a steady-state molar ratio in the range of from about 0.01 to about 0.1, or in a range from about 0.01 to about 0.08, or in a range from about 0.01 to about 0.05.

We claim:

1. A continuous process for converting a carbonaceous feedstock into a plurality of gaseous products, the process comprising the steps of:
(a) supplying a carbonaceous feedstock and a gasification catalyst to a gasification reactor, the gasification catalyst comprising potassium compounds;
(b) reacting the carbonaceous feedstock in the gasification reactor in the presence of steam and the gasification catalyst under suitable temperature and pressure to form:
(i) a plurality of gaseous products comprising methane and at least one or more of hydrogen, carbon monoxide, carbon dioxide, hydrogen sulfide, ammonia, and other higher hydrocarbons; and
(ii) a solid char comprising potassium as soluble and insoluble compounds;
(c) at least partially separating the plurality of gaseous products to produce a gas stream comprising a predominant amount of one of the gaseous products;
(d) recovering the gas stream;
(e) recovering a substantial portion of the potassium compounds from the solid char as potassium carbonate, wherein
(1) at least a portion of the potassium is not recovered from the solid char;
(2) the gasification catalyst and carbonaceous feedstock are provided to maintain a steady-state operational molar ratio of potassium atoms in the catalyst to carbon atoms in the carbonaceous feedstock, the steady-state operational molar ratio ranging from about 0.01 to about 0.08; and
(3) the gasification catalyst comprises the potassium carbonate recovered from the solid char and a makeup potassium hydroxide, the makeup potassium hydroxide added in an amount to maintain the steady-state operational molar ratio.

2. The process according to claim 1, wherein the carbonaceous feedstock comprises a petroleum coke.

3. The process according to claim 1, wherein the carbonaceous feedstock comprises a coal.

4. The process according to claim 1, wherein the carbonaceous feedstock and the gasification catalyst are supplied as a particulate composition having a particle size distribution suitable for gasification in a fluidized bed zone, the particulate composition comprising an intimate mixture of (a) the carbonaceous feedstock and (b) the gasification catalyst which, in the presence of steam and under suitable temperature and pressure, exhibits gasification activity whereby a plurality of gases including methane and at least one or more of hydrogen, carbon monoxide, and other higher hydrocarbons are formed, wherein the particulate composition has a moisture content of less than about 6 wt % based on the weight of the particulate composition.

5. The process according to claim 4, wherein the particulate composition comprises from about 5 wt % to about 25 wt % gasification catalyst.

6. The process according to claim 4, wherein the particle size distribution ranges from about 25 microns to about 2500 microns.

7. The process according to claim 1, wherein the ratio of potassium carbonate to potassium hydroxide ranges from about 1:1 to about 50:1, based on the relative number of moles of potassium.

8. The process according to claim 1, wherein the gas stream comprises a predominant amount of methane.
